(19) United States
(12) Patent Application Publication
(10) Pub. No.: US 2023/0131735 A1
(43) Pub. Date: Apr. 27, 2023

(54) AFFINITY GRAPH EXTRACTION AND UPDATING SYSTEMS AND METHODS

(71) Applicant: NEC Laboratories Europe GmbH, Heidelberg (DE)

(72) Inventors: Ammar Shaker, Heidelberg (DE); Francesco Alesiani, Heidelberg (DE)

(21) Appl. No.: 17/557,231

(22) Filed: Dec. 21, 2021

Related U.S. Application Data
(60) Provisional application No. 63/255,968, filed on Oct. 15, 2021.

(51) Int. Cl. G06N 5/04; G06N 20/00; G06F 16/901

(52) U.S. Cl. CPC G06N 5/041; G06F 16/9024; G06N 20/00

(57) ABSTRACT

A method for affinity graph extraction includes building an affinity graph based on data, the data including multiple elements with undetermined relationships, wherein each element is represented as a node in the affinity graph and relations between nodes are represented as edges in the affinity graph. The method further includes applying a machine learning algorithm to learn node and relation representations in the affinity graph, wherein each edge has a relation type selected from a set of two or more relation types, learning a machine learning scoring function for each relation type, and adjusting the affinity graph based on the scoring function and iteratively repeating operations of applying, learning and adjusting one or more times to determine new relations between nodes representing the undetermined relationships.

### CROSS REFERENCES TO RELATED APPLICATIONS

The present application claims priority to U.S. Provisional Pat. Application No. 63/255,968, filed Oct. 15, 2021, entitled “AFFINITY GRAPH EXTRACTION AND UPDATING,” which is hereby incorporated by reference in its entirety herein.

### FIELD

The present invention relates to a method, system, and computer-readable medium for affinity graph extraction and updating.

### BACKGROUND

Affinity graph learning is the process of discovering a graph of multiple relations between a set of objects. As an example, given a set of products in a shop or store, there may exist hidden relations as to which pair of items cope well and cause an increase of their joint sales, and which pair of products cannibalize each other causing their sales to decrease.

As additional background to the present disclosure, consider [1] Garcia Duran, Alberto, and Mathias Niepert. “Learning graph representations with embedding propagation.” Advances in neural information processing systems 30 (2017): 5119-5130; and [2] Kaneko, Yuta, and Katsutoshi Yada. “A deep learning approach for the prediction of retail store sales.” 2016 IEEE 16th International Conference on Data Mining Workshops (ICDMW). IEEE, 2016—the entire contents of each of which are hereby incorporated by reference herein.

In general, there is a need for improved affinity graph extraction capabilities including optimized automatic decision making based on the extracted affinity graph.

### SUMMARY

According to an embodiment, the present disclosure provides a process for affinity graph extraction, which includes one or more of: gathering, cleaning, and/or summarizing data; conducting affinity graph extraction, preferably through hypothesis testing; learning node and relation representations in the extracted affinity graph; and learning a machine learning scoring function to adjust the affinity graph. A feedback loop may optionally be performed by repeatedly conducting the affinity graph extraction and machine learning operations. The method may further include performing optimization-based automatic decision making.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates diagram flow according to an embodiment of the present disclosure;

FIG. 2 shows an example of an affinity graph between products according to an aspect of the present disclosure;

FIG. 3 shows an example of affinity graph features at a product level;

FIG. 4 shows an example embodiment in a retail setting;

FIG. 5 shows an example embodiment in a smart city setting;

FIG. 6 shows an example embodiment in an online advertising setting; and

FIG. 7 shows an embodiment of a processing system according to the present disclosure.

### DETAILED DESCRIPTION

An embodiment of the present disclosure provides a method for affinity graph extraction, which provides an enhanced data processing mechanism to identify hidden relations (i.e., unidentified relations) between interacting elements in a specific environment. This extraction may be followed by graph updating and adjustment procedures to reflect hidden interactions between the elements.

According to an embodiment, a computer-implemented method for affinity graph extraction includes building an affinity graph based on data, the data including multiple elements with undetermined relationships, wherein each element is represented as a node in the affinity graph and relations between nodes are represented as edges in the affinity graph. The method further includes applying a machine learning algorithm to learn node and relation representations in the affinity graph, wherein each edge has a relation type selected from a set of two or more relation types, learning a machine learning scoring function for each relation type, and adjusting the affinity graph based on the scoring function and iteratively repeating operations of applying, learning and adjusting one or more times to determine new relations between nodes representing the undetermined relationships.

According to an embodiment, the multiple elements represent multiple products and the two or more relation types include a product cannibalization relation type and a product binding relation type.

According to an embodiment, the building the affinity graph includes extracting cannibalizing and binding elements from the data.

According to an embodiment, the method further comprises receiving the data from a distributed network of sensors prior to building the affinity graph.

According to an embodiment, the building the affinity graph is performed using hypothesis testing.

According to an embodiment, the method further comprises performing optimization-based automatic decision making based on the affinity graph.

According to an embodiment, the adjusting includes adding and/or removing an edge between nodes in the affinity graph.

According to an embodiment, the adjusting includes removing an edge between two nodes from the affinity graph if the scoring function for a relation between the two nodes is greater than a threshold value and adding an edge in the affinity graph between the two nodes if the scoring function for the relation between the two nodes is smaller than the threshold value.

According to an embodiment, the applying a machine learning algorithm further learns cardinalities of each of the multiple elements.

According to an embodiment, a system is provided that includes one or more hardware processors which, alone or in combination, are configured to provide for execution of a method of affinity graph extraction comprising building an affinity graph based on data, the data including multiple elements with undetermined relationships, wherein each element is represented as a node in the affinity graph and relations between nodes are represented as edges in the affinity graph, applying a machine learning algorithm to learn node and relation representations in the affinity graph, wherein each edge has a relation type selected from a set of two or more relation types, learning a machine learning scoring function for each relation type; and adjusting the affinity graph based on the scoring function and iteratively repeating the operations of applying, learning and adjusting one or more times to determine new relations between nodes representing the undetermined relationships.

According to an embodiment, the multiple elements represent multiple products and the two or more relation types include a product cannibalization relation type and a product binding relation type.

According to an embodiment, the method further comprises performing optimization-based automatic decision making based on the affinity graph.

According to an embodiment, the adjusting includes adding and/or removing an edge between nodes in the affinity graph.

According to an embodiment, the adjusting includes removing an edge between two nodes from the affinity graph if the scoring function for a relation between the two nodes is greater than a threshold value and adding an edge in the affinity graph between the two nodes if the scoring function for the relation between the two nodes is smaller than the threshold value.

According to an embodiment, a tangible, non-transitory computer-readable medium is provided that includes instructions thereon which, upon being executed by one or more hardware processors, alone or in combination, provide for execution of any method of affinity graph extraction as described herein.

An embodiment of the present disclosure also provides a system for affinity graph extraction, learning, and updating from an environment populated with interacting elements from an element-set. Each element in the element-set may have a number of instantiations (the instantiations may also be referred to as occurrences). The affinity graph holds useful information about different types of interactions between elements. This information is represented by edges between elements, where each edge belongs to one of a set of one or more relation types.

After extracting the affinity graph, according to an aspect of the present disclosure, an adjustment and update procedure is performed based on a novel loss function. Thereafter, a ranking function is learned to validate the necessity of each edge, discover missing edges, and remove noisy edges. Finally, an optimization function is defined and solved.

According to an embodiment of the present disclosure, a method is provided for improved affinity graph extraction through hypothesis testing from time-ordered reports of element data (e.g. periodic, such as daily, summaries of sales data). Hypothesis testing is a standard statistical class of methods. E.g., the hypothesis test for the difference in two population means.

According to an embodiment of the present disclosure, a method may include affinity graph denoising, via: (i) learning the node and relation representation in the extracted affinity graph (loss function); and (ii) learning a machine learning scoring function to adjust the affinity graph by discovering missing edges and removing noisy edges.

According to an embodiment of the present disclosure, the method may include optimizing the environment from which the data is derived are obtained, e.g., such that less cannibalizing and more binding may occur.

An embodiment of the present disclosure provides a system having one or more processors, which are configured to (e.g., execute computer code such that the processors operate to):
1) Receive (and/or collect) data (e.g., sales data) from sensors (e.g., sensors distributed across a shop or shops); and extract time-ordered reports for each element (e.g., periodic summaries for each product — e.g., for each day and each product (i) the number of available items, and (ii) the number of sold items).
2) Build an affinity graph for the elements (e.g., products) using hypothesis testing.
3) Adjust the affinity graph using learned element representation and the learned scoring function for each edge type.
4) Perform assortment and order optimization with the objective of decreasing the cannibalization between elements (e.g., products) and increasing the binding among elements (e.g., products).

Embodiments of the present disclosure can be used to create affinity graphs of competing and binding elements in an environment.

With the support of the defined loss function, the found or created affinity graphs can further be tuned, updated, and improved.

Aspects of the present disclosure may be particularly advantageous where datasets are provided having defined pairs of elements (e.g., where the prerequisites of graphs hold).

Embodiments of the present disclosure provide technical improvements and advantages over the state of the art. In particular, embodiments of the present disclosure improve the functionality of specialty computer systems configured to detect usage of resources (e.g., elements) and optimize the deployment of real-world resources. For example, embodiments of the present disclosure provide enhanced and efficient utilization of memory and processing resources to timely and efficiently uncover unidentified relationships among resources, using machine learning. These detected relationships can then be used in optimization calculations to enable efficient and automatic resource deployment.

Compared to the state of the art, methods according to an embodiment of the present disclosure extract binding and cannibalizing elements (e.g., products from the daily counts of sold and unsold items) to build an affinity graph. Thus, taking into account the psychological effect of the available elements (e.g., products) on the user’s (e.g., customer’s) decisions. After extracting the affinity graph, the node embedding learning and the scoring function helps in de-noising the affinity graph, which leads to an accurate definition of the optimization problem.

Embodiments of the present disclosure are particularly advantageous in retail deployments. In the retail domain, stores or shops generally have an assortment of products (elements) to be offered. Some products in an assortment might be cannibalizing other products (e.g., the availability of one product may cause fewer sold items and an increase of discarded items of the other cannibalized product), or binding other products (i.e., selling more items that sell well together or in an assortment). An extracted affinity graph would carry the interaction information (e.g., relation types of binding or cannibalizing) based on the number of sold, unsold, or discarded items. Finally, an optimization problem may be defined and solved for the automatic ordering of products.

The affinity graphs may be compared between well-performing versus poorly performing shops. This comparison can lead to understanding which pair of cannibalizing products should be avoided to improve profit.

According to an embodiment, the present disclosure provides a process for affinity graph building or extraction from data, which includes one or more of:
1) generating or receiving data (e.g., from a distributed network of sensors);
2) gathering; cleaning, and/or summarizing the generated or received data;
3) conducting affinity graph extraction (e.g., through hypothesis testing);
4) learning node and relation representations in the extracted affinity graph;
5) learning a machine learning scoring function to adjust the affinity graph. Optionally, performing a feedback loop (e.g., back to operation 3); and/or
6) performing optimization-based automatic decision making.

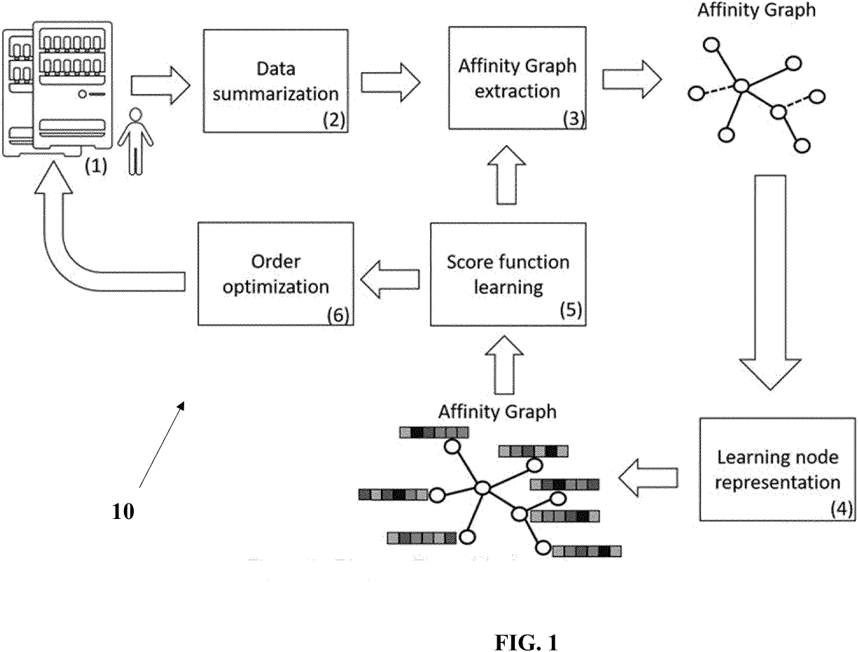

FIG. 1 is a diagram showing a method 10 for affinity graph extraction and data optimization, including a general flow of information, according to an embodiment of the present disclosure. In FIG. 1, briefly, instantaneous data signals (e.g., sales signals) are received, and the affinity graph is created based on an interaction among entities in the data. This affinity graph is then used to extend or generate a knowledge graph of the entities. This information can then be used for automatic order placement for new items.

In step 1, relevant data regarding various entities or elements may be generated. For example, data may be generated by, and/or received from, a distributed network of multiple sensors. In step 2, the data is collected or gathered and cleaned and summarized, which may include, e.g., grouping transactions over a time period such as days, or over products.

In step 3, affinity graph extraction is performed. In an embodiment, affinity graph extraction is performed using hypothesis testing to produce an (extracted) affinity graph based on the received data. For example, in an embodiment of affinity graph extraction:
1) V is defined as the set of elements in the data. Nodes in the affinity graph correspond to elements from V, hence, the terms element and node can be used interchangeably.
2) E is defined as the set of graph edges. Each edge e ∈ E has a relation type eᵣ ∈ R, where R is the set of relation types, and each edge e is a triplet of the form e = (eᵥ, eᵤ, eᵣ) ∈ V × V × R. In this embodiment directed graphs are used. Accordingly, eᵥ is a source node, eᵤ is a destination node, and eᵣ is an edge type. For simplicity, in an embodiment, cannibalization (r_{c}) and binding (r_{b}) may be used as two types of relations, i.e., R = {r_{c}, r_{b}}.

In order to identify the set of cannibalizing and binding elements, statistical tests may be performed for each pair of available elements in the element-set. To this end, in an embodiment, it may be assumed that Aₐ = a₁, ..., aᵢ, ... and Bₐ = b₁, ..., bᵢ, ... are the cardinalities at which elements A and B are available, i.e., number of available items at different times. Aₓ = x₁, ... , xᵢ, ... is a time series of the consumed items of the element A. The mean of remaining items of element A may be tested in two types of occurrences: (i) the occurrences when element B is not offered, i.e., b = 0; and (ii) the occurrences when element B is available, i.e., b > 0. More specifically:

Cannibalism cases may occur when:

$${μ}_{u} = E \left[\frac{a - x}{a} \left|b = 0\right)\right] < E \left[\frac{a - x}{a} \left|b > 0\right)\right] = {μ}_{v}$$

For these cases the test of difference between means (e.g., Welch t-test with unknown variances) may be applied. For example:

$${H}_{0} : {μ}_{v} - {μ}_{u} \leq 0$$

$${H}_{1} : {μ}_{v} - {μ}_{u} > 0$$

$$t = \frac{{μ}_{v} - {μ}_{u}}{s} ; s = \sqrt{\frac{{s}_{u}^{2}}{{n}_{u}} + \frac{{s}_{v}^{2}}{{n}_{u}}}$$

H₀ may be rejected if t > t_{df,α}, which means that element B cannibalizes element A.

Binding cases may occur when, for example:

$${μ}_{u} = E \left[\frac{a - x}{a} \left|b = 0\right)\right] > E \left[\frac{a - x}{a} \left|b > 0\right)\right] = {μ}_{v}$$

For these cases the test of difference may be applied between means (e.g., a Welch t-test with unknown variances). For example:

$${H}_{0} : {μ}_{u} - {μ}_{v} \leq 0$$

$${H}_{1} : {μ}_{u} - {μ}_{v} > 0$$

$$t = \frac{{μ}_{u} - {μ}_{v}}{s} ; s = \sqrt{\frac{{s}_{u}^{2}}{{n}_{u}} + \frac{{s}_{v}^{2}}{{n}_{u}}}$$

H₀ may be rejected if > t_{df,α} , which means element B binds well with element A.

For both aforementioned cases, the degrees of freedom may be computed as follows:

$$d f = \frac{{\left(\frac{{s}_{u}^{2}}{{N}_{u}} + \frac{{s}_{v}^{2}}{{N}_{v}}\right)}^{2}}{\frac{{s}_{u}^{4}}{{N}_{u}^{2} \left({N}_{u} - 1\right)} + \frac{{s}_{v}^{4}}{{N}_{v}^{2} \left({N}_{v}^{2} - 1\right)}}$$

In step 4, the node and relation representations in the extracted affinity graph are learned. In an embodiment, this operation includes applying a machine learning algorithm to learn the feature representation of the elements, relations, and the consumption cardinalities of each element (number of items per element) from the extracted affinity graph. The machine learning algorithm may include graph neural networks or other machine learning algorithms as may be well known to one of skill in the art.

In an embodiment, aspects of this learning operation may be defined as follows:
1) For each element v ∈ V, there are the two temporal lists (e.g., time series) of the cardinality of v’s available items vₐ = a₁, ..., aⱼ, ... and consumed items vₓ = x₁, ... , xⱼ, ...;
2) A parametric function f learns the representation of v ∈ V by taking f (v, vₐ, vₓ);
3) h is an aggregation function, and d is a metric distance function;
4) Nᵣ(v) returns the set of elements (nodes) from V that are connected with the node v ∈ V by a relation type r ∈ R .

The associated set of features are learned for each element of the affinity graph. This is obtained by, e.g., contrastive learning, where the representation of an element is used to reconstruct the representation of nearby elements. The learning may be conducted with an iterative procedure (e.g., Graph Learning) for learning feature(s) for each element.

In an embodiment, the following margin-based loss function may be employed:

$$L = {{\sum }_{v ∈ V} \left[\begin{matrix}d \left(f \left(v , {v}_{a} , {v}_{x}\right) , h \left(\left\{f \left(u , {u}_{a} , {u}_{x}\right) \vert u ∈ {N}_{{r}_{c}} \left(v\right)\right\}\right)\right) - \\ d \left(f \left(v , {v}_{a} , {v}_{x}\right) , h \left(\left\{f \left(u , {u}_{a} , {u}_{x}\right) \vert u ∈ {N}_{{r}_{b}} \left(v\right)\right\}\right)\right) + Δ\end{matrix}\right]}_{+}$$

where [x + Δ ]₊ returns max(0, x + Δ), with Δ being the margin parameter. The first term in the sum penalizes the reconstruction error caused by rebuilding the node v’s representation from its cannibalizing neighbors. While the first part pushes towards the similarity between an element and its cannibalizing surrounding, the second part pushes towards dissimilarity to the binding neighbors. This is motivated by the fact that binding products complement each other while cannibalizing products resemble each other. The loss _{L} aims at having a reconstruction error on cannibalizing products smaller than that of binding products where Δ defines the difficulty of the problem.

In step 5, an operation of a method according to an embodiment of the present disclosure includes learning a machine learning scoring function, which can be used to adjust the affinity graph. Additional details of an embodiment of this operation are provided below.

Having learned the representations for each element in the extracted affinity graph, now, a scoring function Sᵣ: V × V → [0,1] may now be learned for each relation type r ∈ R . Here, the function Sᵣ learns from the binary examples, where (u, v) is a positive example if there is an edge of type r ∈ R connecting the nodes u, v ∈ V, and negative otherwise.

The function Sᵣ plays the role of a feedback loop by discovering links that have been missing in the extracted affinity graph, or even removing noisy edges. To this end, an edge of type r can be added between u and v if Sᵣ(u,v) is greater than a pre-defined threshold δₐ and removed if smaller than the threshold δ_{b}.

In step 6, an operation of a method according to an embodiment of the present disclosure includes performing optimization-based automatic decision making. Additional details of this operation are provided below.

For a model-based optimization, a function is used that takes the extracted affinity graph as input and predicts the potential demand for each product. Consider, for example a case where

$${\hat{d}}_{v , t , o} = M ( v , t , {o}_{v , t} )$$

is a demand function. Here,

$${\hat{d}}_{v , t}$$

is a predicted demand of the product represented by node v at time t, where o_{v,t} is the cardinality of the availability of v. The optimization problem may then be solved according to:

$$a r g {max}_{{o}_{v , t}} {r}_{v , t} = {a}_{v , t} {\hat{d}}_{v , t , o} - {b}_{v} {o}_{v , t} - {c}_{v} \left[{o}_{v , t} - {\hat{d}}_{v , t , o}\right] + δ$$

where:
Week Shop Model (e.g., not sold product discarded at the end of the week)
r_{v,t} is the profit, i.e. difference between revenues and costs for product v at time t
o_{v,t}, b_{v,t}, c_{v,t} : price/cost per product (sale price, cost of storing, disposal cost)
d̅_{v,t,o} the predicted demand for product v at time t
oᵥₚ order for product v at time t
δ is the fixed costs

After finding the right amount of orders oᵥₚ for each product v at time t, an automatic decision is made and orders may be prepared and sent.

Aspects of the present disclosure are also described below in relation to exemplary embodiments. These embodiments are for illustration and aspects of the present disclosure are not limited to features of the described embodiments.

### Exemplary Embodiment 1: Automatization of Shop Operation and Analysis for Retail

As an exemplary embodiment, consider the retail sector, which is expected to benefit from the advantages of the present disclosure. As for the terminology, elements may be considered to be products, and the occurrences may be considered to be the physical realization of the products. Retail shops often have a large assortment of products from which a smaller set of products has to be selected and offered at given times and locations. An assortment that has competing products would not achieve optimal sales targets because this competition leads to increasing discards and/or cannibalization and, hence, less profit. Similarly, having products that bind well together in an assortment leads to overall sales of such products. As an example of competing products, consider two types of rice balls that have the same size, price, preparation methods, and different manufacturers. In that case, the customer might be loyal to this type of product but not necessarily to the producer. Binding products, on the other hand, support each other, such as a bucket of freshly-fried potato chips binds which may sell well with fried chicken, yet, this fried potato chip product may be less attractive when no other fried-meat product is offered.

In this embodiment, shelves may be provided with sensors that trigger a signal whenever a product is being selected/taken by a customer. Alternatively, or additionally, data representative of such signals may be received from a register or set of registers in a store after purchases have been made by shoppers or customers. From these signals, the affinity graph can be extracted.

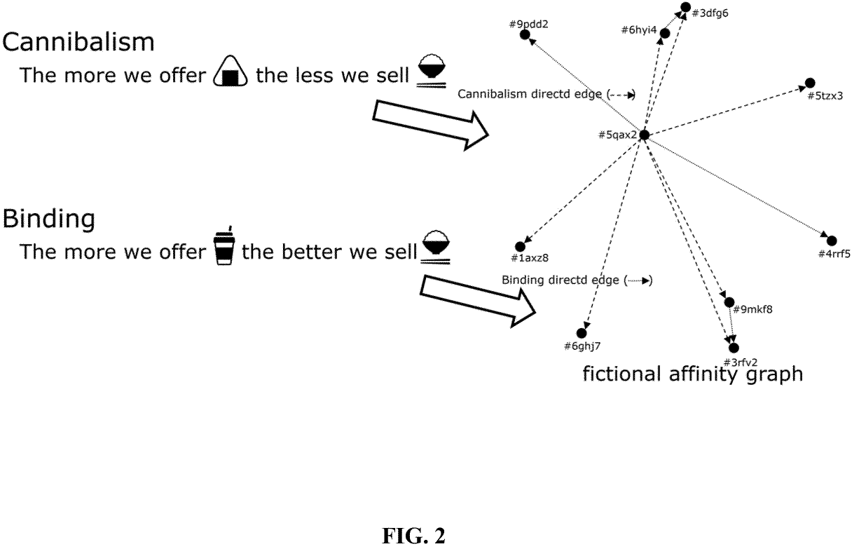

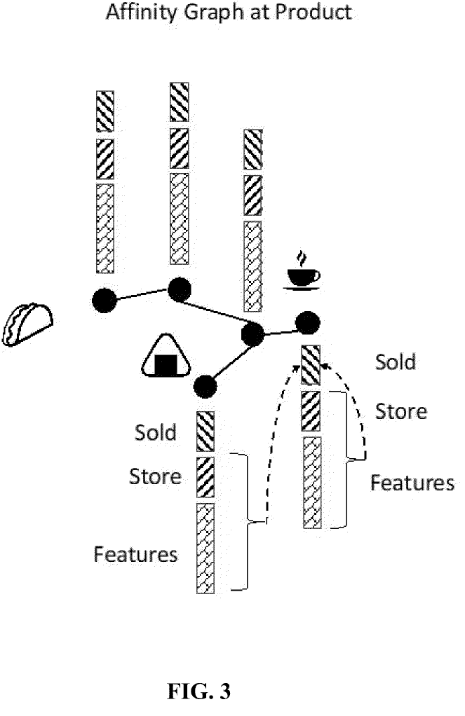

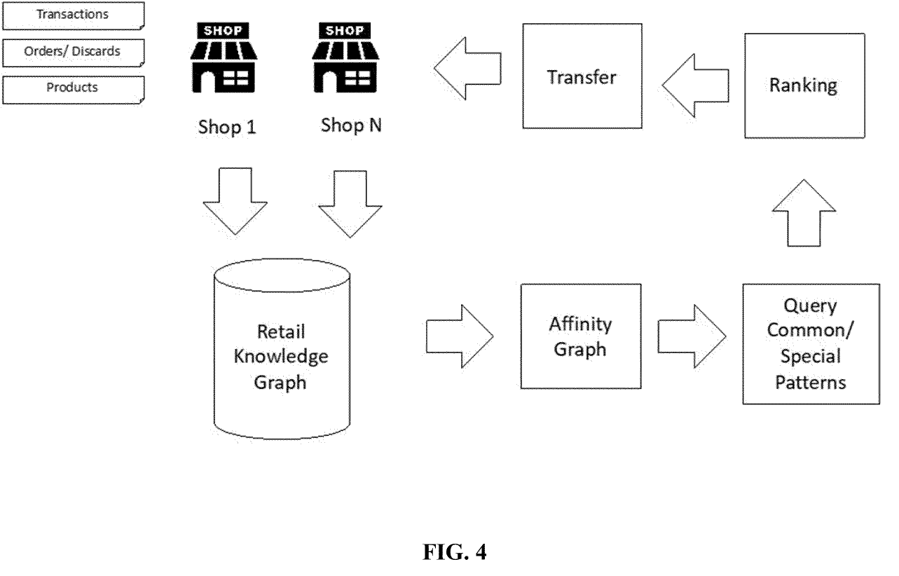

FIG. 2 shows an example of an affinity graph for this retail sector embodiment according to an aspect of the present disclosure. FIG. 3 illustrates an affinity graph at a product level. FIG. 4 illustrates a system according to the present disclosure in the retail setting.

In this embodiment, the set of products that cannibalize each other and the products that bind well together from a given assortment are identified. This identification may be, for example, based on the sales history of a shop or a set of shops. The identification is realized by discovering the affinity graphs, which are then employed by methods for assortment evaluation, sales prediction, and assortment optimization methods.

After extracting or learning the affinity graph from the collected data in one of the aforementioned methods, this graph can be used for one or more of the following targets:
1) Demand prediction: this information is used for preparing and placing shop orders for certain products.
2) Automated ordering and returning of goods: based on historical data and predicted demand, automatic ordering of products is performed. Further unsold products are returned.
3) Shelf and assortment Optimization: based on the cannibalism and binding information and pattern of time of sales, the shelf is optimized in position and time: when and where to move the goods on the shelves.
4) Recommendation for shop ordering scheme: based on sales performance, automatic recommendations are sent to other shops.
5) Transfer learning of successful pattern: based on the shop’s performance: ordering and cooking times are transferred to other shops. This operation is performed using machine learning models trained on single shops and then transmitted to other shops.
6) A query system provides functions to query the affinity graph: it receives a query and then analyzes the data in the database and returns the result. Example queries may include: which shops are similar to a specific shop, and which products are suitable for a specific shop?

### Exemplary Embodiment 2: Smart Cities

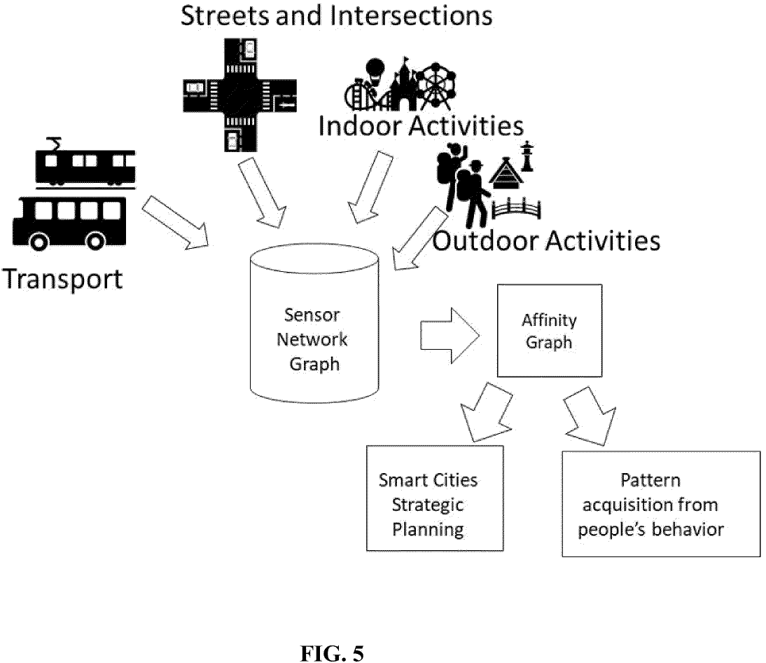

An embodiment of the present disclosure may be adapted for a smart city setting. An example is shown in FIG. 5. This embodiment deviates from retail by considering city locations as the nodes of the graph to be learned or extracted. Such an embodiment can be realized by collecting data from a network of sensors distributed in a city to collect the car counts at different streets and intersections, pedestrian counts at main streets, squares, and event locations. Based on the sensor information, the affinity graphs may be learned using one of the previously mentioned methods.

This smart city affinity graph indicates, for example, how the car flow (or pedestrian flow) develops across the city’s network and the city’s different regions. Studying such a graph at different times helps understand how people’s behavior changes over time, e.g., over years, weeks, and days. This understanding helps in the cities’ strategic planning, such as knowing where a new bus stop, shopping center, or activity park might be required.

### Exemplary Embodiment 3: Online Advertisement

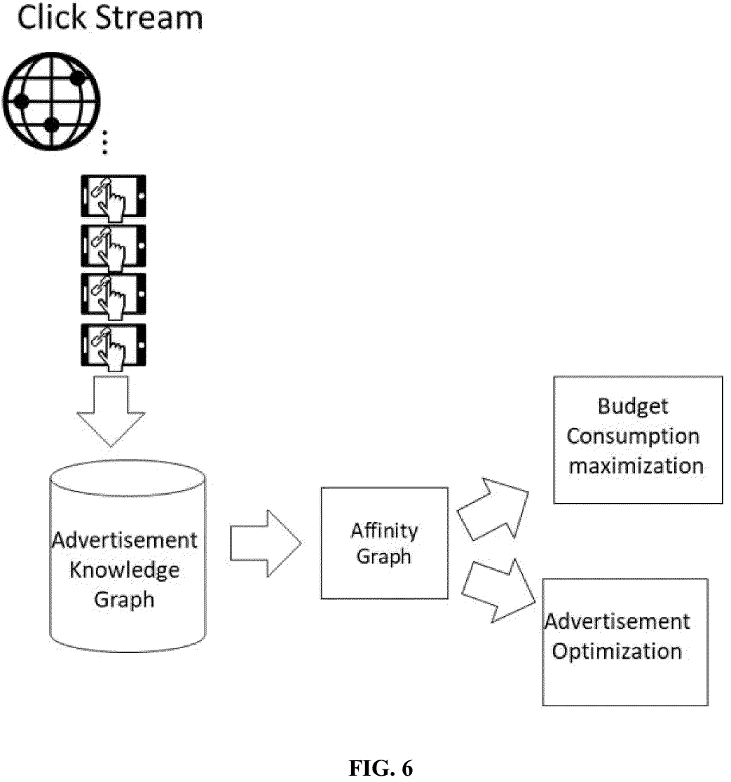

An embodiment of the present disclosure may be adapted for an online advertisement setting. An example is shown in FIG. 6. This embodiment focuses, for example, on the clickstream generated by users choosing between different shown advertisements. Learning the relationship graph between advertisements (elements) helps select the subset of advertisements that reduces cannibalism and increases profit. Such an approach helps to maximize the consumption of the advertiser’s budget while minimizing the chances of not presetting uninteresting advertisements.

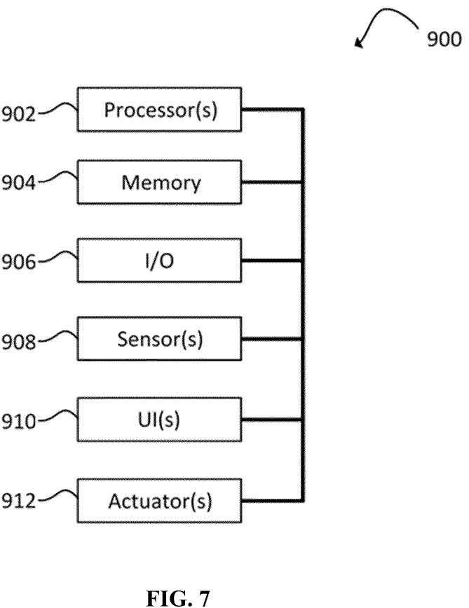

Referring to FIG. 7, a processing system 900 can include one or more processors 902, memory 904, one or more input/output devices 906, one or more sensors 908, one or more user interfaces 910, and one or more actuators 912. Processing system 900 can be representative of each computing system disclosed herein.

Processors 902 can include one or more distinct processors, each having one or more cores. Each of the distinct processors can have the same or different structure. Processors 902 can include one or more central processing units (CPUs), one or more graphics processing units (GPUs), circuitry (e.g., application specific integrated circuits (ASICs)), digital signal processors (DSPs), and the like. Processors 902 can be mounted to a common substrate or to multiple different substrates.

Processors 902 are configured to perform a certain function, method, or operation (e.g., are configured to provide for performance of a function, method, or operation) at least when one of the one or more of the distinct processors is capable of performing operations embodying the function, method, or operation. Processors 902 can perform operations embodying the function, method, or operation by, for example, executing code (e.g., interpreting scripts) stored on memory 904 and/or trafficking data through one or more ASICs. Processors 902, and thus processing system 900, can be configured to perform, automatically, any and all functions, methods, and operations disclosed herein. Therefore, processing system 900 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 900 can be configured to perform task “X”. Processing system 900 is configured to perform a function, method, or operation at least when processors 902 are configured to do the same.

Memory 904 can include volatile memory, non-volatile memory, and any other medium capable of storing data. Each of the volatile memory, non-volatile memory, and any other type of memory can include multiple different memory devices, located at multiple distinct locations and each having a different structure. Memory 904 can include remotely hosted (e.g., cloud) storage.

Examples of memory 904 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 904.

Input-output devices 906 can include any component for trafficking data such as ports, antennas (i.e., transceivers), printed conductive paths, and the like. Input-output devices 906 can enable wired communication via USB®, DisplayPort®, HDMI®, Ethernet, and the like. Input-output devices 906 can enable electronic, optical, magnetic, and holographic, communication with suitable memory 906. Input-output devices 906 can enable wireless communication via WiFi®, Bluetooth®, cellular (e.g., LTE®, CDMA®, GSM®, WiMax®, NFC®), GPS, and the like. Input-output devices 906 can include wired and/or wireless communication pathways.

Sensors 908 can capture physical measurements of environment and report the same to processors 902. For example, as described above sensor may be provided on shelves in a retail setting in order to detect customer interactions with the goods. User interface 910 can include displays, physical buttons, speakers, microphones, keyboards, and the like. Actuators 912 can enable processors 902 to control mechanical forces.

Processing system 900 can be distributed. For example, some components of processing system 900 can reside in a remote hosted network service (e.g., a cloud computing environment) while other components of processing system 900 can reside in a local computing system. Processing system 900 can have a modular design where certain modules include a plurality of the features/functions shown in FIG. 7. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for affinity graph extraction, the method comprising:
a) building an affinity graph based on data, the data including multiple elements with undetermined relationships, wherein each element is represented as a node in the affinity graph and relations between nodes are represented as edges in the affinity graph;
b) applying a machine learning algorithm to learn node and relation representations in the affinity graph, wherein each edge has a relation type selected from a set of two or more relation types;
c) learning a machine learning scoring function for each relation type; and
d) adjusting the affinity graph based on the scoring function and iteratively repeating operations b), c), and d) one or more times to determine new relations between nodes representing the undetermined relationships.

2. The method according to claim 1, wherein the multiple elements represent multiple products and the two or more relation types include a product cannibalization relation type and a product binding relation type.

3. The method according to claim 1, wherein the building the affinity graph includes extracting cannibalizing and binding elements from the data.

4. The method according to claim 1, the method comprising receiving the data from a distributed network of sensors prior to building the affinity graph.

5. The method according to claim 1, wherein the building the affinity graph is performed using hypothesis testing.

6. The method according to claim 1, further comprising performing optimization-based automatic decision making based on the affinity graph.

7. The method according to claim 1, wherein the adjusting includes adding and/or removing an edge between nodes in the affinity graph.

8. The method according to claim 1, wherein the adjusting includes removing an edge between two nodes from the affinity graph if the scoring function for a relation between the two nodes is greater than a threshold value and adding an edge in the affinity graph between the two nodes if the scoring function for the relation between the two nodes is smaller than the threshold value.

9. The method according to claim 1, wherein the applying a machine learning algorithm further learns cardinalities of each of the multiple elements.

10. A system comprising one or more hardware processors which, alone or in combination, are configured to provide for execution of a method of affinity graph extraction comprising:
a) building an affinity graph based on data, the data including multiple elements with undetermined relationships, wherein each element is represented as a node in the affinity graph and relations between nodes are represented as edges in the affinity graph;
b) applying a machine learning algorithm to learn node and relation representations in the affinity graph, wherein each edge has a relation type selected from a set of two or more relation types;
c) learning a machine learning scoring function for each relation type; and
d) adjusting the affinity graph based on the scoring function and iteratively repeating operations b), c), and d) one or more times to determine new relations between nodes representing the undetermined relationships.

11. The system of claim 10, wherein the multiple elements represent multiple products and the two or more relation types include a product cannibalization relation type and a product binding relation type.

12. The system of claim 10, wherein the method further comprises performing optimization-based automatic decision making based on the affinity graph.

13. The system of claim 10, wherein the adjusting includes adding and/or removing an edge between nodes in the affinity graph.

14. The system of claim 10, wherein the adjusting includes removing an edge between two nodes from the affinity graph if the scoring function for a relation between the two nodes is greater than a threshold value and adding an edge in the affinity graph between the two nodes if the scoring function for the relation between the two nodes is smaller than the threshold value.

15. A tangible, non-transitory computer-readable medium having instructions thereon which, upon being executed by one or more hardware processors, alone or in combination, provide for execution of a method of affinity graph extraction comprising:
a) building an affinity graph based on data, the data including multiple elements with undetermined relationships, wherein each element is represented as a node in the affinity graph and relations between nodes are represented as edges in the affinity graph;
b) applying a machine learning algorithm to learn node and relation representations in the affinity graph, wherein each edge has a relation type selected from a set of two or more relation types;
c) learning a machine learning scoring function for each relation type; and
d) adjusting the affinity graph based on the scoring function and iteratively repeating operations b), c), and d) one or more times to determine new relations between nodes representing the undetermined relationships.
